(19) United States
(12) Patent Application Publication
(10) Pub. No.: US 2025/0043100 A1
(43) Pub. Date: Feb. 6, 2025

(54) ELASTOMER PRODUCT

(71) Applicant: Continental Reifen Deutschland GmbH, Hannover (DE)

(72) Inventors: Tiago Moura, Hannover (DE); Thomas Kramer, Herford (DE); Michael Schunack, Hannover (DE)

(73) Assignee: Continental Reifen Deutschland GmbH, Hannover, OT (DE)

(21) Appl. No.: 18/696,544

(22) PCT Filed: Aug. 12, 2022
(86) PCT No.: PCT/DE2022/200181

§ 371 Date: Mar. 28, 2024

(30) Foreign Application Priority Data
Sep. 28, 2021 (DE) 10 2021 210 783.4

(51) Int. Cl. C08K 3/06; B60C 1/00; B60C 9/00; B60C 9/04; C08K 3/04; C08K 5/098; C08K 5/3492; C08K 5/47

(52) U.S. Cl. CPC C08K 3/06; B60C 1/0041; B60C 9/0007; C08K 3/04; C08K 5/098; C08K 5/34922; C08K 5/47; B60C 2001/0066; B60C 2009/0021; B60C 2009/0458

(57) ABSTRACT

The invention relates to an elastomer product having at least one strength member ply embedded into a vulcanizable rubber compound, where the strength member ply is formed from a multitude of steel cords that each consist of at least two helically twisted filaments or at least two strands formed from two or more mutually helically twisted filaments, and the cords have an elongation at break of at least 5% and an elongation under a tensile stress of 100 N of at least 3.5%, and the vulcanizable rubber compound, as well as natural rubber and/or synthetic rubber, contains sulfur and/or sulfur donors and accelerators, and the elongation of the cords after complete vulcanization of the rubber compound under a tensile stress of 100 N is reduced by at least 10% compared to the state prior to the vulcanization.

### CROSS-REFERENCE TO RELATED APPLICATIONS

The present application is a National Stage Application under 35 U.S.C. § 371 of International Patent Application No. PCT/DE2022/200181 filed on Aug. 12, 2022, the disclosures of which are herein incorporated by reference in their entireties.

### SUMMARY

The invention relates to an elastomer product which has at least one strength member ply embedded in a vulcanizable rubber compound, wherein the strength member ply is formed from a multiplicity of steel cords which each consist of at least two helically twisted filaments or at least two strands formed from a plurality of helically mutually twisted filaments.

Such elastomer products are known and serve, for example, for production of continuous belts, rubber caterpillar tracks or conveyor belts, and for formation of parts or components in tire building, especially for pneumatic vehicle tires. For example, such elastomer products are used in the region of the carcass and the belt in pneumatic vehicle tires for passenger vehicles and light goods vehicles. Typically, the cords are produced from steel wires, but these are disadvantageous because they have only low longitudinal elasticity, for example in the case of what are called 0° steel belts. Such 0° jointless bandages are used in high-performance tires for cars and motorcycles and comprise cords oriented exactly in running direction of the tire. Commonly used in such cases, therefore, are textile materials such as PA 6.6 or hybrid cords, for example made of PA 6.6 and aramid fibers. A disadvantage of such cords that do not consist of steel is their low modulus of elasticity, and high costs in the case of use of aramid fibers. Moreover, the use of textile materials as cord impairs the rolling resistance properties of a pneumatic vehicle tire equipped therewith because of the inherent hysteresis, and can also promote the occurrence of flat spots under unfavorable conditions. Moreover, in the pneumatic vehicle tire, when textile cords are used, unwanted stresses/deformations can occur, which promote variances from the desired tire shape. Moreover, the high-speed performance of such pneumatic vehicle tires is in need of improvement.

It is an object of the invention to improve an elastomer product of the type specified at the outset so as to overcome the disadvantages of the prior art.

### BRIEF DESCRIPTION OF THE SEVERAL VIEWS OF THE DRAWINGS

FIG. 1 is a drawing of a filament 1, which has been isolated from a cord.

### DETAILED DESCRIPTION

In the proposal of the invention, steel cords are arranged with helically twisted filaments in the elastomer product, where the cords have an elongation at break of at least 5% and an elongation under a tensile stress of 100 N of at least 3.5%, and the vulcanizable rubber compound, as well as natural rubber and/or synthetic rubber, contains sulfur and/or sulfur donors and accelerators as further constituents, and the elongation of the cords after complete vulcanization of the rubber compound under a tensile stress of 100 N is reduced by at least 10% compared to the state prior to the vulcanization.

In other words, the invention proposes the selection of specific steel cords that are characterized by a stress-strain curve that shows an elongation at break of at least 5% and a strain under a low load of 100 N of at least 3.5%. Prior to the vulcanization of the vulcanizable rubber compound, the elastomer product of the invention thus achieves high elasticity even under low tensile load, which is advantageous in a tire building process, for example, particularly when the tire blank containing the elastomer product of the invention is expanded in a tire building machine.

This is attributable to the twisted or intertwined configuration of the individual filaments in the cords, since clear interspaces are obtained in this way between adjacent filaments, which permit slight extensibility under low applied tensile stress in that the cord is constricted with increasing length.

On the other hand, however, the inventive adjustment of the formulation of the vulcanizable rubber compound used in the elastomer product of the invention ensures that it completely fills the interspaces present between the individual filaments of the cord and adjacent cords of the strength member ply during and after vulcanization and enters into particularly high adhesion therewith, such that the originally present high extensibility of at least 3.5% under a tensile load of 100 N after complete vulcanization of the rubber compound is significantly reduced by at least 10%, preferably far more, and in the ideal state is virtually completely eliminated. In this way, the elastomer product of the invention, in the final state, i.e. after complete vulcanization of the rubber compound, shows distinctly reduced material hysteresis, which is manifested, for example, in a significant improvement in rolling resistance performance and better high-speed characteristics when the elastomer product is used in a pneumatic vehicle tire. In addition, the occurrence of flat spots or of variances in the tire shape is also effectively prevented. Moreover, the strength member ply of the elastomer product of the invention can also be produced at much lower cost compared to the use of textile materials.

In one proposal of the invention, steel cords used for the elastomer product of the invention comprise a number of n filaments having a respective cross-sectional area A, measured in mm², where a single cord is formed from a steel material with modulus of elasticity E and, under a tensile stress of 0.5 N per filament present in the cord, has a centerline that runs helically and a pitch L₀, and a value P in N according to equation (1) of at least 50 N:

$$P = π nE {( \frac{A}{S} )}^{2} \qquad equation ( 1 )$$

where S is the length of the centreline of a filament isolated from the cord over the course of one complete pitch, measured in mm. The number of such pitches per 1 meter is typically reported in t/m (turns/meter).

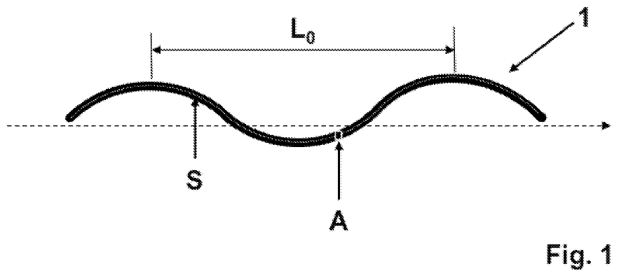

The aforementioned dimensions are apparent from the drawing of a filament 1 reproduced in FIG. 1, which has been isolated from a cord of the invention.

The helical progression with a constant pitch is apparent, which results in a pitch L₀. The pitch L₀ represents the axial distance between two corresponding spatial positions in the cross section of the filament 1.

In addition, the length S of the centerline of the filament 1 is also apparent over the course of one complete pitch L₀, as is the constant cross-sectional area A of the filament.

The length S can be ascertained, for example, by an axial scan device as described in WO 95/16816 A1.

Such steel cords are formed from steel having a modulus of elasticity of about 200 000 N/mm². The value P is thus a measure of the tensile rigidity of the cords at low elongation. Values of P that are particularly suitable in accordance with the invention are between 50 N and 250 N.

Examples of suitable steels for formation of the cords include carbon steels having a low carbon content between 0.04 and 0.20 percent by weight, stainless steel, and carbon steels having a high carbon content of at least 0.65 percent by weight.

In a further proposal of the invention, the filaments have an equivalent diameter d, defined by equation (2), where the ratio S:d is less than 30:

$$A = \frac{π {d}^{2}}{4} . \qquad ( 2 )$$

In a further proposal of the invention, the L₀:S ratio is less than 0.95.

In the context of the invention, it is considered to be advisable for a single cord, if it is formed from strands of mutually helically twisted filaments, to comprise preferably two, three or four such strands.

The number of filaments in a single strand is preferably one, two or three such filaments.

The total number n of filaments present in one cord is preferably between two and eight such filaments, which may be the same or different from one another.

In a further proposal of the invention, the vulcanizable rubber compound comprises sulfur and/or sulfur donor, especially in an amount of 2 to 8 phr, preferably about 4 to 6 phr.

The formulation figures above and also hereinafter that use the unit phr (part per hundred parts of rubber weight) are always based on 100 parts by weight of natural and/or synthetic rubber in the rubber compound.

In this respect, the vulcanization is performed in the presence of sulfur and/or sulfur donors, and some sulfur donors can simultaneously act as vulcanization accelerators. Sulfur or sulfur donors are added to the rubber compound in the amounts commonly used by those skilled in the art in the last mixing step. Sulfur is preferably used in oil-extended form. In this way, the sulfur can be incorporated and dispersed more easily and uniformly.

In addition to the sulfenimide accelerators and the dibenzylamine-based sulfenamide accelerators, the rubber compound may also contain further vulcanization-influencing substances such as further vulcanization accelerators, vulcanization retarders and vulcanization activators in customary amounts. The rubber compound preferably contains, aside from the sulfenimide accelerators and the dibenzylamine-based sulfenamide accelerators, less than 0.5 phr of other vulcanization accelerators.

In a further proposal of the invention, the rubber compound contains accelerators in an amount of 0.5 to 3 phr, preferably 0.8 to 1.5 phr, preferably in the form of a sulfenimide accelerator and/or of at least one dibenzylamine-based sulfenamide accelerator.

In particular, the accelerator may be selected from the group encompassing N-cyclohexyl-2-benzothiazolesulfenamide (CBS), N,N-dicyclohexylbenzothiazole-2-sulfenamide (DCBS), benzothiazyl-2-sulfenmorpholide (MBS) and N-tert-butyl-2-benzothiazylsulfenamide (TBBS).

In preferred embodiments of the invention, the rubber compound contains DCBS as accelerator. Because of the comparatively slow reaction kinetics, this is found to be particularly advantageous for the adhesion of the cords in the rubber compound.

Sulfenimide accelerators are vulcanization accelerators based on primary amines. By contrast, sulfenamide accelerators such as DCBS (N,N′-dicyclohexyl-2-benzothiazolesulfenamide) or MBS (N-oxydiethylene-2-benzothiazolesulfenamide) are based on secondary amines. There may be one or more sulfenimide accelerators in the rubber compound.

For a particularly balanced ratio of scorch time t₁₀ and optimal vulcanization time t₉₀, the sulfenimide accelerator is N-tert-butyl-2-benzothiazolesulfenimide (TBSI, IUPAC name: N,N-bis(1,3-benzothiazol-2-ylsulfanyl)-2-methylpropan-2-amine). The use of the sulfenimide accelerator N-tert-butyl-2-benzothiazolesulfenimide (TBSI) as vulcanization accelerator in cobalt-containing rubberization mixtures is known, for example, from US 2010/0200141 A1 and U.S. Pat. No. 6,120,911. Scorch time t₁₀ denotes the time by which about 10% of the rubber compound has vulcanized and, correspondingly, the optimal vulcanization time t₉₀ the time by which about 90% of the rubber compound has vulcanized.

In order to further improve the durability of the rubber-metal adhesion within the elastomer product of the invention with regard to oxidative aging processes, it has been found to be advantageous when the rubber compound contains 2 to 10 phr of zinc oxide.

In order to further improve adhesion, the rubber compound may contain methylene acceptor-methylene donor pairs in customary amounts, especially 5 to 15 phr. Methylene acceptors used may be resorcinol-based methylene acceptors or specific novolak resins, such as Alnovol® PN 760/Past, from Allnex Netherlands B. V. Methylene donors/formaldehyde donors present may, for example, be etherified melamine resins. Etherified melamine resins include, for example, hexamethoxymethylmelamine (HMMM) and hexamethylenetetramine (HMT).

In addition, the rubber compound may contain further adhesion stabilizers that are effective after vulcanization, such as sodium hexamethylene-1,6-bisthiosulfate dihydrate (NaO₃SS(CH₂)₆SSO₃Na·2H₂O).

The sulfur-crosslinkable rubber compound contains further constituents that are customary in the rubber industry, especially at least one natural rubber and/or synthetic rubber.

Rubbers used may be diene rubbers. Diene rubbers include all rubbers having an unsaturated carbon chain which at least partly derive from conjugated dienes.

The rubber compound may contain polyisoprene (IR, NR) as diene rubber. This may be either cis-1,4-polyisoprene or 3,4-polyisoprene. Preference is given, however, to the use of cis-1,4-polyisoprenes with a cis-1,4 content >90% by weight. Such a polyisoprene is firstly obtainable by stereospecific polymerization in solution with Ziegler-Natta catalysts or using finely divided lithium alkyls. Secondly, natural rubber (NR) is one such cis-1,4-polyisoprene, the cis-1,4 content in natural rubber being greater than 99% by weight Natural rubber is understood to mean rubber that can be obtained by harvesting from sources such as rubber trees (Hevea brasiliensis) or non-rubber tree sources (for example guayule or dandelion (e.g. Taraxacum koksaghyz)).

If the rubber compound contains polybutadiene (BR) as the diene rubber, this may be cis-1,4-polybutadiene. Preference is given to the use of cis-1,4-polybutadiene with a cis-1,4 content greater than 90% by weight, which is producible, for example, by solution polymerization in the presence of rare earth catalysts.

Further diene rubbers that are usable include vinyl-polybutadienes and styrene-butadiene copolymers. The vinyl-polybutadienes and styrene-butadiene copolymers may be solution-polymerized (styrene)-butadiene copolymers (S-(S)BR) having a styrene content, based on the polymer, of about 0% to 45% by weight and a vinyl content (content of 1,2-bonded butadiene, based on the total polymer) of 10% to 90% by weight, which may be produced using lithium alkyls in organic solvent for example. The S-(S)BR may also be coupled and endgroup-modified. However, it is also possible to use emulsion-polymerized styrene-butadiene copolymers (E-SBR) and mixtures of E-SBR and S-(S)BR. The styrene content of the E-SBR is about 15% to 50% by weight, and it is possible to use the products known from the prior art that have been obtained by copolymerization of styrene and 1,3-butadiene in aqueous emulsion.

The diene rubbers used in the rubber compound, especially the styrene-butadiene copolymers, can also be used in partly or fully functionalized form. The functionalization can be effected with groups which can interact with the fillers used, especially with fillers bearing OH groups. These may be for example functionalizations with hydroxyl groups and/or epoxy groups and/or siloxane groups and/or amino groups and/or phthalocyanine groups and/or carboxy groups and/or silane sulfide groups. The diene rubbers may additionally or alternatively also be coupled.

However, as well as the diene rubbers mentioned, the rubber compound may also contain other rubber types, for example styrene-isoprene-butadiene terpolymer, butyl rubber, halobutyl rubber or ethylene-propylene-diene rubber (EPDM).

Regenerate (reclaim) may also be added to the rubber compound as a processing aid and to make the mixture cheaper.

The rubber compound may contain different fillers, such as carbon blacks, silicas, aluminosilicates, chalk, starch, magnesium oxide, titanium dioxide or rubber gels, in customary amounts, where the fillers may be used in combination.

If carbon black is used in the rubber compound, the types used are preferably those having a CTAB surface area (to ASTM D 3765) of more than 30 m²/g. These are readily incorporable and ensure low heat buildup.

If silicas are present in the rubber compound, these may be silicas customary for tire rubber mixtures. It is particularly preferable to employ a finely divided, precipitated silica having a CTAB surface area (to ASTM D 3765) of 30 to 350 m²/g, preferably of 110 to 250 m²/g. Employable silicas include both conventional silicas, such as those of the VN3 type (trade name) from Evonik, or highly dispersible silicas known as HD silicas (e.g. Ultrasil 7000 from Evonik).

If the rubber compound contains silica or other polar fillers, silane coupling agents may be added to the rubber compound in order to improve processibility and to bind the polar filler to the rubber. The silane coupling agents react with the surface silanol groups of the silica or other polar groups during the mixing of the rubber/the rubber compound (in situ) or in the context of a pretreatment (premodification) even before addition of the filler to the rubber. Silane coupling agents that may be used here include any silane coupling agents known to those skilled in the art for use in rubber mixtures. Such coupling agents known from the prior art are bifunctional organosilanes having at least one alkoxy, cycloalkoxy or phenoxy group as a leaving group on the silicon atom and having, as another functionality, a group that, after cleavage if necessary, can enter into a chemical reaction with the double bonds of the polymer. The latter group may for example comprise the following chemical groups: —SCN, —SH, —NH₂ or —Sₓ— (with x=2-8). Silane coupling agents that may be used thus include, for example, 3-mercaptopropyltriethoxysilane, 3-thiocyanatopropyltrimethoxysilane or 3,3′-bis(triethoxysilylpropyl) polysulfides having 2 to 8 sulfur atoms, for example 3,3′-bis(triethoxysilylpropyl) tetrasulfide (TESPT), the corresponding disulfide, or else mixtures of the sulfides having 1 to 8 sulfur atoms with different contents of the various sulfides. The silane coupling agents may also be added here as a mixture with industrial carbon black, for example TESPT to carbon black (trade name: X50S from Evonik). Blocked mercaptosilanes as known for example from WO 99/09036 may also be used as a silane coupling agent. It is also possible to use silanes as described in WO 2008/083241 A1, WO 2008/083242 A1, WO 2008/083243 A1 and WO 2008/083244 A1. It is possible to use, for example, silanes which are sold under the NXT name in a number of variants by Momentive, USA, or those that are sold under the VP Si 363 name by Evonik Industries. Also usable are “silated core polysulfides” (SCPs, polysulfides with a silylated core), which are described, for example, in US 20080161477 A1 and EP 2 114 961 B1.

Furthermore, the rubber compound may contain standard additives in customary proportions by weight. These additives include plasticizers, for example glycerides, factices, hydrocarbon resins, aromatic, naphthenic or paraffinic mineral oil plasticizers (for example MES (mild extraction solvate) or TDAE (treated distillate aromatic extract)), oils based on renewable raw materials (for example rapeseed oil, terpene oils (for example orange oils) or factices), what are called BTL oils (as disclosed in DE 10 2008 037714 A1) or liquid polymers (for example liquid polybutadiene); aging inhibitors, for example N-phenyl-N′-(1,3-dimethylbutyl)-p-phenylenediamine (6PPD), N-isopropyl-N′-phenyl-p-phenylenediamine (IPPD), 2,2,4-trimethyl-1,2-dihydroquinoline (TMQ) and other substances, as known for example from J. Schnetger, Lexikon der Kautschuktechnik [Lexicon of Rubber Technology], 2nd edition, Hüthig Buch Verlag, Heidelberg, 1991, pages 42-48, activators, for example fatty acids (for example stearic acid), waxes, tackifier resins, for example hydrocarbon resins and rosin, and mastication aids, for example 2,2′-dibenzamidodiphenyldisulfide (DBD).

In addition, the cords of the elastomer product of the invention may also have a surface coating in order to further improve adhesion to the rubber compound. In this connection, preference is given especially to copper-based alloys such as brass and bronze. In such a case, in a further proposal of the invention, the rubber compound of the invention, for further improvement of adhesion, additionally also includes cobalt salts containing 0.03% to 0.15% by mass of cobalt, preferably 0.03% to 0.12% by mass of cobalt, as adhesion promoter. Cobalt salts used may, for example, be cobalt stearate, cobalt borate, cobalt borate alkanoate, cobalt naphthenate, cobalt thiocyanate, cobalt octoate, cobalt adipate, etc.; the use of cobalt stearates and/or cobalt borates and/or cobalt naphthenates and/or cobalt borate alkanoates is particularly advantageous for bonding properties.

The rubber compound is produced in a conventional manner, by first generally preparing a base mixture containing all the constituents except for the vulcanization system (sulfur and vulcanization-influencing substances), in one or more mixing stages, and subsequently producing the finished mixture of the vulcanizable rubber compound by adding the vulcanization system. Subsequently, the rubber compound is processed further, in the course of which the cords are also embedded. Finally, complete vulcanization of the rubber compound results in final completion of the elastomer product of the invention.

The invention is elucidated further hereinafter by reference to working examples.

An elastomer product suitable for use as a component of a pneumatic vehicle tire was produced by first making up a vulcanizable rubber compound of the formulation reproduced in tab. 1 below under customary conditions in a tangential laboratory mixer:

TABLE 1

| Constituents | Unit | Proportion |
|---|---|---|
| Natural rubber (polyisoprene) | phr | 100 |
| Carbon black | phr | 63 |
| Plasticizer and aging stabilizer | phr | 9.6 |
| Cobalt stearate | phr | 1.3 |
| Methylene acceptor-methylene | phr | 7.2 |
| donor pair | | |
| DCBS accelerator | phr | 0.75 |
| Sulfur, ext. with 33% by wt. of oil | phr | 6.75 |

In addition, 0.15 mm-thick filaments of unalloyed carbon steel were helically twisted together in the same direction of rotation, in order subsequently to form a 3×2×0.15 cord as strength member from such twisted strands. The filaments were bonded at 208 t/m to give helically twisted or intertwined strands and then together at 158 t/m to give a cord.

Subsequently, the cords thus formed were embedded into two samples of the vulcanizable rubber compound according to table 1, with application of an initial tensile load of 0.4 or 5 kg to the ends of the cords. Subsequently, the rubber compound with the embedded cords was fully vulcanized and the tensile strength of the samples was tested in accordance with test standard ASTM D2969 on a Zwick Z010 tester.

In addition, the steel cord on its own, not embedded into a rubber compound, was compared to the two elastomer products created with different initial load in order to be able to make a comparison between the strain properties before vulcanization and after vulcanization. Tensile strength was measured with an applied tensile strain of 50 N, 100 N and 150 N.

The results are reported in tab. 2.

TABLE 2

| | Variant | | |
|---|---|---|---|
| Mechanical | | 3 × 2 × 0.15 | 3 × 2 × 0.15 |
| properties | 3 × 2 × 0.15 | vulcanized with | vulcanized with |
| of the cord | steel cord alone | initial load 0.4 kg | initial load 5 kg |
| Elongation | 3.60 | 1.10 | 0.30 |
| at 50N (%) | | | |
| Elongation | 4.00 | 1.80 | 0.60 |
| at 100N (%) | | | |
| Elongation | 4.20 | 2.30 | 0.90 |
| at 150N (%) | | | |

It was found that the elastomer product of the invention, after complete vulcanization, undergoes a distinct decrease in elongation of well above 10% under the low tensile load of 100 N. This suggests that the elastomer products will be particularly suitable especially for applications in tire building, for example for carcasses, belts and jointless bandages of high-performance pneumatic car tires.

The elastomer products of the invention can additionally be used in a wide variety of different rubber products including cords. As well as tires, these rubber products may especially also include (continuous) drive belts, conveyor belts, hoses, rubberized fabrics or air springs. The tires may be car tires, van tires, truck tires, industrial tires, bicycle tires, agricultural vehicle tires or aircraft tires.

1. An elastomer product having at least one strength member ply embedded into a vulcanizable rubber compound, where the strength member ply is formed from a multitude of steel cords that each consist of at least two helically twisted filaments or at least two strands formed from two or more mutually helically twisted filaments, and the cords have an elongation at break of at least 5% and an elongation under a tensile stress of 100 N of at least 3.5%, and the vulcanizable rubber compound, as well as natural rubber and/or synthetic rubber, contains sulfur and/or sulfur donors and accelerators, and the elongation of the cords after complete vulcanization of the rubber compound under a tensile stress of 100 N is reduced by at least 10% compared to the state prior to the vulcanization.

2. The elastomer product as claimed in claim 1, characterized in that the cords comprise a number of n filaments having a respective cross-sectional area A, measured in mm², where a single cord is formed from a steel material with modulus of elasticity E and, under a tensile stress of 0.5 N per filament present in the cord, has a centerline that runs helically and a pitch L₀, and a value P in N according to equation (1) of at least 50 N:
$$P = π {nE ( \frac{A}{S} )}^{2} \qquad ( 1 )$$
where S is the length of the centreline of a filament isolated from the cord over the course of one complete pitch, measured in mm.

3. The elastomer product as claimed in claim 2, characterized in that the filaments have an equivalent diameter d, defined by equation (2), where the ratio S:d is less than 30:
$$A = \frac{π {d}^{2}}{4} . \qquad ( 2 )$$

4. The elastomer product as claimed in either of claims 2 and 3, characterized in that the ratio L₀:S is less than 0.95.

5. The elastomer product as claimed in any of claims 1 to 4, characterized in that the vulcanizable rubber compound contains sulfur and/or sulfur donor in an amount of 2 to 8 phr, preferably of 4 to 6 phr.

6. The elastomer product as claimed in any of claims 1 to 5, characterized in that the rubber compound contains accelerators in an amount of 0.5 to 3 phr, preferably of 0.8 to 1.5.

7. The elastomer product as claimed in any of claims 1 to 6, characterized in that the accelerator is based on sulfenimide or sulfenamide, and is especially selected from the group encompassing N-cyclohexyl-2-benzothiazolesulfenamide (CBS), N,N-dicyclohexylbenzothiazole-2-sulfenamide (DCBS), benzothiazyl-2-sulfenmorpholide (MBS) and N-tert-butyl-2-benzothiazylsulfenamide (TBBS).

8. The elastomer product as claimed in any of claims 1 to 7, characterized in that the cord has a surface coating based on brass and the rubber compound also includes cobalt salts containing 0.03% to 0.15% by mass of cobalt.

9. The elastomer product as claimed in claim 8, characterized in that the cobalt salts are selected from the group encompassing cobalt stearate, cobalt borate, cobalt borate alkanoate, cobalt naphthenate, cobalt thiocyanate, cobalt octoate and cobalt adipate.

10. The elastomer product as claimed in any of claims 1 to 9, characterized in that the rubber mixture also contains methylene acceptor-methylene donor pairs in a collective amount of 5 to 15 phr.

11. A pneumatic vehicle tire containing an elastomer product as claimed in any of the preceding claims.

12. A continuous belt, rubber caterpillar track or conveyor belt, formed from an elastomer product as claimed in any of the preceding claims.
